(19) United States
(12) Patent Application Publication
(10) Pub. No.: US 2025/0316209 A1
(43) Pub. Date: Oct. 9, 2025

(54) DISPLAY PIXEL COMPRISING LIGHT-EMITTING DIODES AND DISPLAY SCREEN HAVING SUCH DISPLAY PIXELS

(71) Applicant: Aledia, Echirolles (FR)

(72) Inventors: Jaehoon Lee, Grenoble (FR); Ivan Petkov, Saint Martin D'Heres (FR)

(73) Assignee: Aledia, Echirolles (FR)

(21) Appl. No.: 18/877,944

(22) PCT Filed: Jun. 27, 2023
(86) PCT No.: PCT/EP2023/067510

§ 371 Date: Dec. 20, 2024

(30) Foreign Application Priority Data
Jun. 29, 2022 (FR) 2206567

(51) Int. Cl. G09G 3/32

(52) U.S. Cl. CPC G09G 3/32; G09G 2300/0814; G09G 2300/0857; G09G 2310/0286; G09G 2310/08; G09G 2320/064

(57) ABSTRACT

A display pixel including at least one light-emitting diode, and an electronic circuit including a storage circuit for storing at least one digital signal and a driver circuit configured to drive said light-emitting diode by pulse-width modulation, in a first operating mode, by switching on or off said light-emitting diode during first different durations according to the logical states of the bits of the digital signal or, in a second operating mode, by switching on or off said light-emitting diode during second different durations, at least partly different from the first durations, according to the logical states of the bits of the digital signal.

This application claims the priority benefit of French patent application number 22/06567, filed on 29 Jun. 2022, entitled “Display pixel comprising light-emitting diodes and display screen having such display pixels”, which is hereby incorporated by reference to the maximum extent allowable by law.

### TECHNICAL FIELD

The present disclosure concerns a display pixel comprising light-emitting diodes and a display screen having such display pixels.

### BACKGROUND ART

A pixel of an image corresponds to the unit element of the image displayed by a display screen. For the display of color images, the display screen generally comprises, for the display of each pixel of the image, at least three components, also called display sub-pixels, which each emit a light radiation, called image pixel color component substantially in a single color (for example, red, green, and blue). The superposition of the image pixel color components emitted by the three display sub-pixels provides the observer with the colored sensation corresponding to the pixel of the displayed image. In this case, the assembly formed by the three display sub-pixels used for the display of a pixel of an image is called display pixel of the display screen. Each display sub-pixel may comprise a light source, particularly a light-emitting diode.

The display pixels may be distributed in an array, each display pixel being located at the intersection of a row (also called line) and of a column of the array. Electrodes are provided along the rows and the columns to connect each display pixels to control circuits. Generally, each row of display pixels is successively selected by signal transmitted along the row electrodes, and the display pixels of the selected row are programmed to display the desired image pixels by signals transmitted along the column electrodes.

The human eyes are much more sensitive to changes in dark tones than they are to similar changes in bright tones. A photodetector usually provides an analog electric image pixel signal that has a substantially linear relationship with the number of photons hitting the sensor. If the display system was operated with a digital driving method such as pulse-width modulation operation, a high number of bits would need to be used for the digital image pixel signals for the dark tones to be described with enough precision. A digitalization with a low number of bits results in a posterization of the displayed image for the dark tones.

To optimize the usage of bits when encoding an image and/or to optimize the bandwidth used to transport an image, a non-linear operation, generally called gamma encoding or gamma compression, is applied to image pixel signal provided by the photodetector to redistribute native image sensor tonal levels into ones which are more perceptually uniform for the human eyes. Gamma encoding is for example defined by the following power-law expression:

Vout=Vin^{γ}

where the non-negative real input value Vin is raised to the power γ to get the output value Vout, with, for example, Vin and Vout in the range 0-1. The exponent γ usually is equal to 1/2.2. To display the image pixel, the inverse non-linear operation, called gamma decoding or gamma expansion, is applied to the image pixel signal to effectively convert it back into light from the original scene.

FIG. 1 shows an example of an ideal gamma decoding function Igam corresponding to a power-law expression with exponent equal to 2.2, and, by comparison, a linear function Lin. In FIG. 1, the y-axis indicates the number of levels of the output and the number of levels of the luminance L of the image pixel is indicated on the x-axis. To make tones appear smooth and continuous in an image, it is usually enough to be able to code at least 256 different levels for the luminance L, which should theoretically only require 8 bits.

However, when using a gamma encoding and a gamma decoding, a posterization can still appear on the displayed image for very dark tones when the display system is operated with a digital driving method such as pulse-width modulation operation.

FIG. 2 shows an enlarged view of the ideal gamma decoding function Igam of FIG. 1 and the gamma decoding function Rgam10 really obtained with a coding on 10 bits. As it appears on FIG. 2, curve Rgam10 is a step curve. This means for example that an image pixel with an ideal luminance L in the range 0-8 result in the display of an image pixel having a real luminance L equal to 0, or that an image pixel with an ideal luminance L in the range 9-13 result in the display of an image pixel with a real luminance L having a constant value. A coding on at least 16 bits should be used for the dark tones to be displayed correctly even when using gamma encoding and gamma decoding. However, the increase of the number of bits of the digital image pixel signals requires a higher bandwidth interface for video data, which is not desirable.

### SUMMARY OF INVENTION

An object of an embodiment is to provide a display pixel comprising light-emitting diodes and a display screen comprising such display pixels overcoming all or part of the disadvantages of existing display pixels comprising light-emitting diodes and display screens comprising such display pixels.

Another object is to reduce, even to suppress, the posterization of a displayed image for the dark tones.

Another object is that the number of bits of the digital image pixel signals remains low.

One embodiment provides a display pixel comprising at least one light-emitting diode, and an electronic circuit comprising a storage circuit for storing at least one digital signal and a driver circuit configured to drive said light-emitting diode by pulse-width modulation, in a first operating mode, by switching on or off said light-emitting diode during first different durations according to the logical states of the bits of the digital signal or, in a second operating mode, by switching on or off said light-emitting diode during second different durations, at least partly different from the first durations, according to the logical states of the bits of the digital signal.

This allows to increase the number of different durations for the control of the light-emitting diode by pulse-width modulation without increasing the number of bits of the digital signal, therefore without increasing the bandwidth interface for video data.

According to an embodiment, the electronic circuit is configured to switch between the first and second operating modes according to the logical state of a first binary signal. This allows to increase the precision of the coding of the pixel image only for dark tones where the human eyes are the most sensitive.

According to an embodiment, the electronic circuit is configured to receive the first binary signal from outside the display pixel. The first binary signals can be advantageously determined by the control circuit of a display screen comprising the display pixels.

According to an embodiment, the digital signal comprises NB bits bᵢ, i being in the range from 1 to NB, bit b_{NB} being the most significant bit and bit bᵢ being the least significant bit, the first durations comprising NB first durations TAᵢ of increasing values, the second durations comprising NB second durations TBᵢ of increasing values, the driver circuit being configured to drive said light-emitting diode by pulse-width modulation in the first operating mode by switching on or off said light-emitting diode during the NB first durations TAᵢ, said light-emitting diode being switched on during first duration TAᵢ when bit bᵢ is at a first logical state and being switched off during first duration TAᵢ when bit bᵢ is at a second logical state, different from the first logical state, and the driver circuit being configured to drive said light-emitting diode by pulse-width modulation in the second operating mode by switching on or off said light-emitting diode during the NB second durations TBᵢ, said light-emitting diode being switched on during second duration TBᵢ when bit bᵢ is at the first logical state and being switched off during second duration TBᵢ when bit bᵢ is at the second logical state.

According to an embodiment, wherein at least some of the second durations are inferior to the first durations. According to an embodiment, at least one of the second durations lasts as long as one of the first durations. According to an embodiment, at least the longest second duration lasts as long as one of the first durations.

According to an embodiment, the display pixel comprises at least a first conductive pad intended to receive a second binary signal comprising pulses, and connected to said electronic circuit, some of said pulses being distant from the first durations and some of said pulses being distant from the second durations, said electronic circuit being configured to switch on or off said light-emitting diode during the first durations or the second durations based on said pulses. The electronic circuit of each display pixel can advantageously generate a pulse-width modulation control signal in the first operating mode and in the second operating mode based on pulses. According to an embodiment, the pulses comprise first pulses, the first pulses being distant from the first durations, and further comprise second pulses, each first pulse being followed by a second pulse, the first pulses and the following second pulses being distant from the second durations. The duration of a cycle in a pulse-width modulation control in the first operating mode or the second operation mode is advantageously not increased with respect to a pulse-width modulation control in a single operation mode.

According to an embodiment, the electronic circuit is configured to generate a third binary signal from the second binary signal with a logical state that is modified at each first pulse and at each second pulse. The third binary signal can therefore be set at logical level “1” during the second durations.

According to an embodiment, the storage circuit comprises a shift register in which is stored the digital signal and configured to provide the successive bits of the stored digital signal clocked by the third binary signal.

According to an embodiment, the display pixel comprises a controllable current source supplying said light-emitting diode and controlled by a fourth binary signal.

According to an embodiment, the electronic circuit comprises a first logic gate of NOR type having a first input receiving the third binary signal and having a second input receiving the first binary signal and a second logic gate of NOR type having a first input receiving the logical complement of bit bᵢ and having a second input connected to the output of first logic gate and providing the fourth binary signal.

According to an embodiment, the display pixel comprises at least a second conductive pad intended to receive a fifth binary signal, and connected to said electronic circuit, said electronic circuit being configured to update said stored digital signal in the storage circuit from the second signal.

Another embodiment provides a display screen comprising:
display pixels as previously disclosed arranged in rows and in columns;
first electrically conductive tracks extending along the rows and connected to the electronic circuits of the display pixels;
second electrically conductive tracks extending along the columns and connected to the electronic circuits of the display pixels; and
a control circuit connected to the first electrically conductive tracks and the second electrically conductive tracks.

According to an embodiment, the electronic circuit of each display pixel is configured to switch between the first and second operating modes according to the logical state of a first binary signal. The control circuit is configured to determine the first binary signal for each digital signal and provide the first binary signals to the display pixels.

According to an embodiment, the control circuit is configured to supply a timing signal on each first electrically conductive track, and the electronic circuit of each display pixel is configured to generate from said timing signal a drive signal to drive said light-emitting diode by pulse-width modulation, in a first operating mode, by switching on or off said light-emitting diode during the first different durations or, in a second operating mode, by switching on or off said light-emitting diode during the second different durations. The generation of the first and second durations by each display pixel is performed from the timing signal. The structure of the electronic circuit can advantageously be simple.

According to an embodiment, the control circuit is configured to supply the timing signal on each first electrically conductive track equal to a second binary signal comprising at least first pulses, the first pulses being distant from the first durations and second pulses, each first pulse being followed by a second pulse, the first pulses and the following second pulses being distant from the second durations. A single timing signal is advantageously used by the display pixel to obtain the first and second durations. This allows advantageously the number of conductive pads of the display pixel to be reduced.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1, already disclosed, shows an example of an ideal gamma decoding function;

FIG. 2, already disclosed, shows an enlarged view of the ideal gamma decoding function of FIG. 1 and a real gamma decoding function with 10-bit encoding;

FIG. 3 partially and schematically shows an embodiment of a display screen;

FIG. 4 shows a block diagram of an embodiment of a display pixel of the display screen of FIG. 3;

FIG. 5 shows timing diagrams of signals used by the display pixel of FIG. 4 for controlling a light-emitting diode according to a known pulse-width modulation method;

FIG. 6 shows timing diagrams of signals used by the display pixel of FIG. 4 for controlling a light-emitting diode according to an embodiment of pulse-width modulation method;

FIG. 7 shows a block diagram of an embodiment of a part of the display pixel of FIG. 4;

FIG. 8 shows a block diagram of a part of circuit of FIG. 7;

FIG. 9 shows an enlarged view of the ideal gamma decoding function of FIG. 1 and a real gamma decoding function with 9-bit encoding with a known method for displaying an image;

FIG. 10 shows an enlarged view of the ideal gamma decoding function of FIG. 1 and a real gamma decoding function obtained with the embodiment of the method for displaying an image;

FIG. 11 is a very simplified cross-section view of a display pixel; and

FIG. 12 is a bottom view of the display pixel of FIG. 11.

### DESCRIPTION OF EMBODIMENTS

Like features have been designated by like references in the various figures. In particular, the structural and/or functional features that are common among the various embodiments may have the same references and may dispose identical structural, dimensional and material properties. For the sake of clarity, only the steps and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Further, a signal which alternates between a first constant state, for example, a low logical state, noted “0”, and a second constant state, for example, a high logical state, noted “1”, is called a “binary signal”. The high and low states of different binary signals of a same electronic circuit may be different. In practice, the binary signals may correspond to voltages or to currents which may not be perfectly constant in the high or low state. Further, in the following description, the source and the drain of a MOS transistor are called “power terminals” of the insulated gate field-effect transistor, or MOS transistor.

Further, unless indicated otherwise, when it is spoken of a voltage at a conductive pad, the difference between the potential at said conductive pad and a reference potential, for example, the ground, taken as equal to 0 V, is considered.

Unless specified otherwise, the expressions “around”, “approximately”, “substantially” and “in the order of” signify within 10%, and preferably within 5%. Further the expression “substantially constant” means which varies by less than 10% over time with respect to a reference value.

In the following specification, embodiments are disclosed for a color display screen comprising color display pixels, each display pixel comprising light-emitting diodes adapted to emit radiations of different colors. However, these embodiments also apply for a monochromatic display screen comprising monochromatic display pixels, each monochromatic display pixel comprising one light-emitting diode or only light-emitting diodes adapted to emit a radiation of a single color.

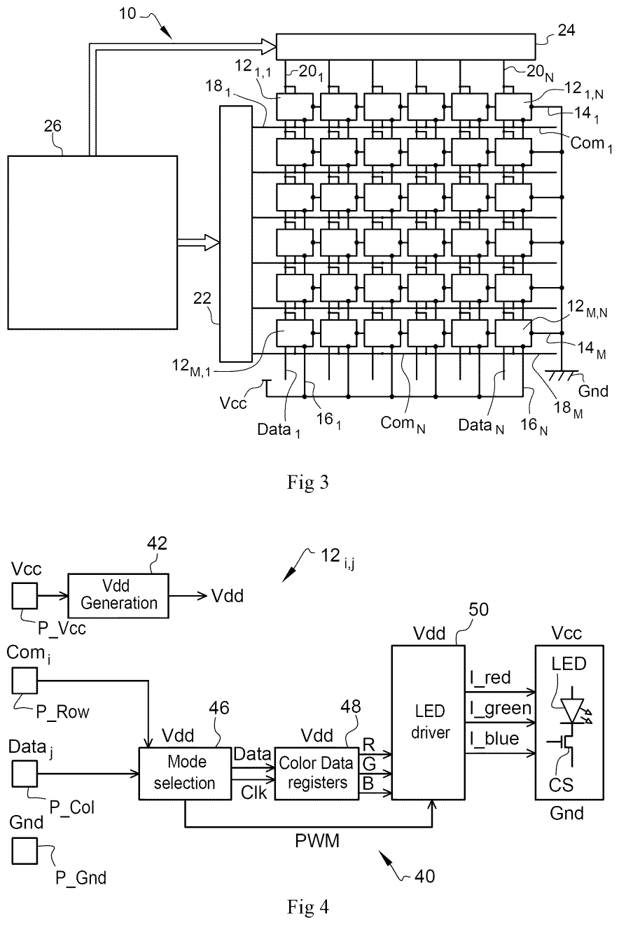

FIG. 3 partially and schematically shows an embodiment of a display screen 10. Display screen 10 comprises display pixels 12_{i,j}, for example, arranged in M rows and in N columns, M being an integer varying from 1 to 8,000 and N being an integer varying from 1 to 16,000, i being an integer varying from 1 to M, and j being an integer varying from 1 to N. As an example, in FIG. 3, M and N are equal to 6. Each display pixel 12_{i,j} is coupled to a source of a low reference potential Gnd, for example, the ground, via an electrode 14ᵢ and to a source of a high reference potential Vcc via an electrode 16ⱼ. As an example, electrodes 14ᵢ are shown as being aligned along the rows in FIG. 3 and electrodes 16ⱼ are shown as being aligned along the columns in FIG. 3, the reverse layout being possible. The power supply voltage of the display screen corresponds to the voltage between high reference potential Vcc and low reference potential Gnd. The power supply voltage particularly depends on the arrangement of the light-emitting diodes and on the technology according to which the light-emitting diodes are manufactured. As an example, the power supply voltage may be in the order of from 4 V to 5 V.

For each row, the display pixels 12_{i,j} in the row are coupled to at least one row electrode 18ᵢ. For each column, the display pixels 12_{i,j} in the column are coupled to at least one column electrode 20ⱼ. Display screen 10 comprises a timing circuit 22 coupled to row electrodes 18; and adapted to delivering a timing signal Comᵢ on each row electrode 18ᵢ. Display screen 10 comprises a data delivery circuit 24 coupled to column electrodes 20ⱼ and adapted to delivering a data signal Data; on each column electrode 20ⱼ. Timing circuit 22 and data delivery circuit 24 are controlled by a circuit 26, for example comprising a microprocessor. In particular, circuit 26 receives the video data to be displayed by display pixels 12_{i,j}.

Generally, each row of display pixels is successively selected, and the display pixels of the selected row are programmed to display the desired image pixels. In a known method for selecting display pixels, timing circuit 22 is adapted to delivering timing signals Comᵢ on row electrodes 18ᵢ to successively select each row of display pixels 12_{i,j} and data delivery circuit 24 is adapted to delivering data signals Dataⱼ on each column electrode 20; representative of color digital data that are stored in the selected display pixels 12_{i,j}.

FIG. 4 shows a block diagram of an embodiment of a display pixel 12_{i,j} of display screen 10. For a color display screen, display pixel 12_{i,j} comprises at least three light-emitting diodes emitting radiations of different colors, a single light-emitting diode LED being shown in FIG. 4. Each light-emitting diode LED is series-coupled to a controllable current source CS, for example comprising a MOS transistor. In the present example, for each light-emitting diode LED, the anode of light-emitting diode LED receives high reference potential Vcc, received at a conductive pad P_Vcc of the display pixel 12_{i,j}, and the cathode of light-emitting diode LED is for example coupled to a terminal of controllable current source CS, the other terminal of controllable current source CS receiving low reference potential Gnd, received at a conductive pad P_Gnd of the display pixel 12_{i,j}. As a variation, the cathode of light-emitting diode LED receives low reference potential Gnd and the anode of light-emitting diode LED is coupled to a terminal of controllable current source CS, the other terminal of controllable current source CS receiving high reference potential Vcc.

Display pixel 12_{i,j} further comprises a circuit 40 for driving controllable current source CS. Driver circuit 40 may particularly comprise electronic components such as MOS transistors. It may be desirable to use a decreased power supply voltage, smaller than 4 V, for example in the order of 1 V or of 1.8 V, to power the electronic components of driver circuit 40, this decreased power supply voltage for example corresponding to the voltage likely to be applied between the power terminals of the MOS transistors. For this purpose, display pixel 12_{i,j} may comprise a circuit 42 (Vdd Generation) for delivering, from power supply voltage Vcc, a decreased power supply voltage Vdd particularly used for the power supply of driver circuit 40. Circuit 42 for example comprises a voltage divider.

According to an embodiment, timing signal Comᵢ, received at a conductive pad P_Row of each display pixel 12_{i,j}, is a binary signal alternating between a low logical state “0” and a high logical state “1”, the low logical state corresponding to low reference potential Gnd and the high logical state “1” corresponding to a low voltage, for example, approximately 1 V, smaller than decreased power supply voltage Vdd. Data signal Dataⱼ, received at a conductive pad P_Col of each display pixel 12_{i,j}, is a binary signal alternating between a low logical state “0” and a high logical state “1”, the low logical state corresponding to low reference potential Gnd and the high logical state “1” corresponding to a low voltage, for example, approximately 1 V, smaller than decreased power supply voltage Vdd.

Driver circuit 40 comprises a circuit 46 (Mode selection) coupled to conductive pad P_Col receiving data signal Dataⱼ and coupled to conductive pad P_Row receiving timing signal Comᵢ and configured to deliver a clock signal Clk from timing signal Comᵢ or data signal Dataⱼ and a data signal Data from data signal Dataⱼ to a storage circuit 48 (Color Data registers) or to deliver a modulation timing signal PWM from timing signal Comᵢ to a circuit 50 (LED driver) for controlling the controllable current source CS associated with each light-emitting diode LED. Modulation timing signal PWM can be equal to timing signal Comᵢ during a display phase. Clock signal Clk can be equal to timing signal Comᵢ during a programming phase.

Storage circuit 48 is configured, when clocked by clock signal Clk, to store digital color signals R, G, B based on received digital data Data. Digital color signals R, G, B are representative of the image pixel color components to be displayed. Each color digital signal R, G, B comprises NB bits called bitⱼ with j in the range from 1 to NB, with bit_{NB} being the most significant bit and bit₁ the least significant bit. Circuit 50 (LED driver) is configured to control the controllable current sources CS coupled to light-emitting diodes LED with binary signals I_red, I_green, and I_blue, obtained from digital color signals R, G, B, and from modulation timing signal PWM.

A known method for driving the light emitting diode LED of display pixel 12_{i,j} is pulse-width modulation driving in which each light emitting diode LED of display pixel 12_{i,j} is supplied with pulses of a current having a constant intensity, the durations of the pulses depending of the stored digital color signals R, G, B.

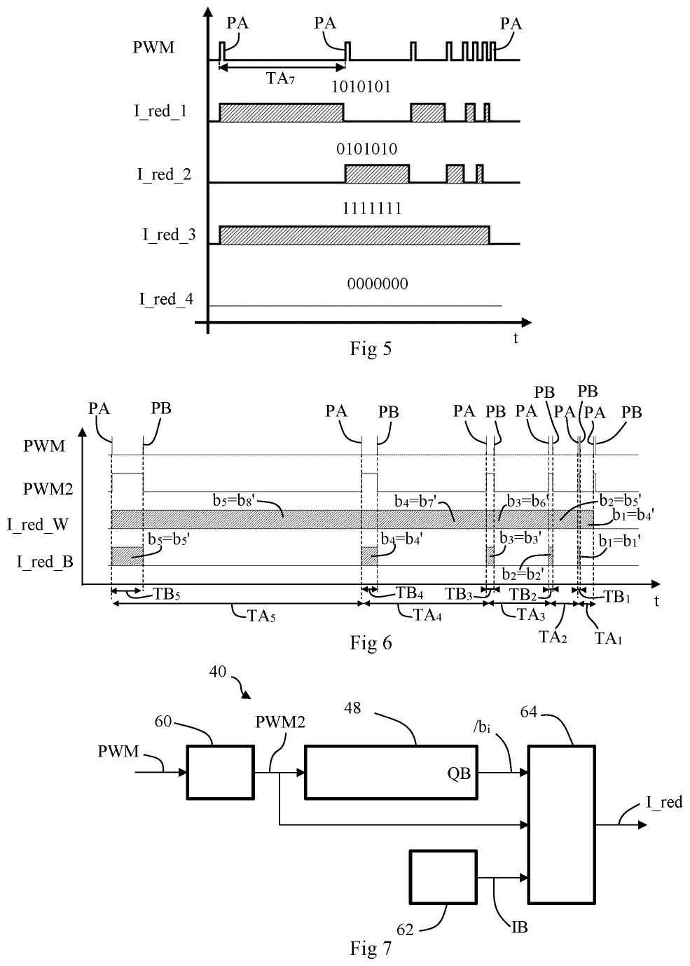

FIG. 5 shows a timing diagram of modulation timing signal PWM and signals I_red_1, I_red 2, I_red 3, and I_red 4, corresponding to signal I_red provided by circuit 50 of display pixel 12_{i,j} of FIG. 4 for the display of four different digital color signals R, using a known pulse-width modulation driving. For this purpose, during a display phase, timing signal PWM exhibits a succession of pulses PA at logical state “1” which rates the operation of circuit 50 for the control of each light-emitting diode LED by pulse-width modulation. The number of pulses PA in the succession of pulses can be equal to NB+1.

As an example, when current source CS corresponds to a MOS transistor, this transistor is turned on or is turned off, at the rate of the pulses of modulation timing signal PWM, according to the logical value “0” or “1” of each bit of color signal R, starting by the most significant bit of color signal R, this transistor being maintained on or off until the next pulse of modulation timing signal PWM. The duration TAᵢ, i being in the range from 1 to NB, between two successive pulses PA of modulation timing signal PWM is divided each time by two, so that the total duration for which the light-emitting diode is on depends on the value of digital color signal R. The succession of pulses PA of modulation timing signal PWM can be repeated until the display of another image pixel. In that case, the succession of pulses PA of modulation timing signal PWM from the most significant bit of color signal R to the least significant bit of color signal R forms a display cycle and the display phase comprises more than one display cycle.

In FIG. 5, as an example, the number of pulses PA in a display cycle of modulation timing signal PWM is equal to 8 and only one display cycle is shown. Signal I_red_1 is obtained for the display of an image pixel color component corresponding to digital color signal R equal to “1010101”. Signal I_red_2 is obtained for the display of an image pixel color component corresponding to digital color signal R equal to “0101010”. Signal I_red_3 is obtained for the display of an image pixel color component corresponding to digital color signal R equal to “1111111”. Signal I_red_4 is obtained for the display of an image pixel color component corresponding to digital color signal R equal to “0000000”.

According to an embodiment, modulation timing signal PWM is modified with respect to a known modulation timing signal PWM so that more than NT different durations for switching on/off the light emitting diodes are available, where NT is an integer strictly superior to NB, preferably superior to NB+1, most preferably superior to NB+2. The display method according to the present embodiment with the modified modulation timing signal PWM providing NT different durations and a digital color signal comprising NB bits is equivalent to a display method in which the known modulation timing signal PWM would provide NT different durations and a digital color signal would comprise NT bits.

FIG. 6 shows a timing diagram of signals PWM, PWM2, I_red_W, and I_red_B according to an embodiment of a method for driving the light emitting diodes LED of display pixel 12_{i,j} of FIG. 4 for which light-emitting diodes LED are controlled by pulse-width modulation. Signals I_red_W, and I_red_B correspond to signal I_red provided by circuit 50 of display pixel 12_{i,j} of FIG. 4 for the display of two different digital color signals R. Signal PWM2 is a signal generated by the circuit 40 of display pixel 12_{i,j} of FIG. 4. In FIG. 6, digital color signal R comprises 5 bits, bit₁ to bit₅, bit₅ being the most significant bit and bit₁ being the least significant bit.

According to an embodiment, modulation timing signal PWM comprises, for a display cycle, alternate first and second pulses, each first pulse PA being followed by a second pulse PB. The first pulses PA correspond to the pulses PA of the modulation timing signal previously disclosed in relation to FIG. 5, that is to say that the duration TAᵢ, i being in the range from NB to 1, between two successive first pulses PA of modulation timing signal PWM in a display cycle is divided each time by two. The duration TBⱼ, j being in the range from NB to 1, between a first pulse PA and the successive second pulse PB of modulation timing signal PWM is divided by two with respect to the duration between the preceding successive first pulse PA and second pulse PB. Signal PWM2 comprises a rising edge at each first pulse PA and a falling edge at each second pulse PB. Therefore, the pulses of signal PWM2 have durations TB_{NB} to TB₁.

According to an embodiment, a cycle comprises NB+1 first pulses PA and NB+1 second pulses PB. Therefore, there are NB decreasing durations TAᵢ, i being in the range from NB to 1, between couples of successive first pulses PA and there are NB decreasing durations TBᵢ, i being in the range from NB to 1, between couples of successive first and second pulses PA, PB.

More generally, timing signal PWM comprises pulses, some of said pulses being distant from the first durations TAᵢ, i being in the range from 1 to NB, and some of said pulses being distant from the second durations TBᵢ, i being in the range from 1 to NB. For example, the pulses used to determine the first durations TAᵢ could precede or follow the pulses used to determine the second durations TBᵢ. However, the embodiment disclosed previously in which first and second pulses PA, PB are alternate allows advantageously to not to increase the duration of the display cycle with respect to a case where only the first durations TAᵢ would be used.

According to an embodiment, in a display cycle, one or more, but not all, of durations TB₁ to TB_{NB} last as long as at least one of durations TA_{NB} to TA₁. According to an embodiment, the duration TB_{NB} between the first pulse PA and the successive second pulse PB at the very beginning of the display cycle lasts as long as the duration TA_{NB} to TA₁ between two successive first pulses PA around the end of the display cycle, for example the duration between the second to last first pulse and the last first pulse of the display cycle, or the duration between the third to last first pulse and the second to last first pulse of the display cycle. There are NT durations of different values in the group comprising all the durations TA_{NB} to TA₁ and TB_{NB} to TB₁, with NT strictly superior to NB and strictly inferior to 2*NB.

In FIG. 6, modulation timing signal PWM comprises 6 first pulses PA that are alternate with 6 second pulses PB. The duration TB_{NB} between the first succession of first and second pulses PA and PB from the beginning of the display cycle lasts as long as the duration TA₂ between the third to last first pulse and the second to last first pulse of the display cycle, and the duration TB_{NB-1} between the second succession of first and second pulses PA and PB from the beginning of the display cycle lasts as long as the duration TA₁ between the second to last first pulse and the last first pulse of the display cycle. The last second pulse PB, shown in FIG. 6, following the last first pulse PA is not used so that it could be absent, even though, in practice, it may be easier to generate a second pulse PB after each first pulse PA to simplify the generation of signal PWM2.

According to an embodiment, an index IB is associated which each value of digital color signal R, G, B. Index IB can be a binary value. During a display operation, according to the logical state of index IB, either durations TA_{NB} to TA₁ or durations TB_{NB} to TB₁ are used to drive light emitting diode LED.

According to an embodiment, index IB is determined by circuit 26 for each initial digital color signal determined by circuit 26 corresponding to an image pixel to be displayed by display pixel 12_{i,j} and is then sent to display pixel 12_{i,j}. Index IB received by display pixel 12_{i,j} can be stored in a memory of display pixel 12_{i,j}. According to an embodiment, index IB can be determined by circuit 26 based on a bit or bits among bit₁ to bit_{NB} of initial digital color signal R, G, or B determined by circuit 26, for example at least one of the most significant bit bit_{NB}, the second to the most significant bit bit_{NB-1}, and the third to the most significant bit bit_{NB-2} of initial digital color signal R, G, or B determined by circuit 26. Index IB can be determined by circuit 26 using logical gates. According to an embodiment, index IB is at a first logical state, for example logical state “1”, for an image pixel having a light tone and index IB is at a second logical state, for example logical state “0”, for an image pixel having a dark tone. According to an embodiment, index IB can be set to the logical state “0” if all of bits b_{NB} to b_{NB-NIB} of initial digital color signal R, G, or B, NIB being an integer, for example equal to 0, 1, or 2, determined by circuit 26 are at the logical state “0” and index IB can be set to the logical state “1” if at least one of bits b_{NB} to b_{NB-NIB} of initial digital color signal R, G, or B, NIB being an integer, for example to 0, 1, or 2, determined by circuit 26 is at logical state “1”.

According to an embodiment, according to the index IB determined based on an initial digital color signal R, G, or B, circuit 26 can calculate a new digital color signal R, G, or B and data signals Dataⱼ sent to pixel 12_{i,j} correspond then to the new digital color signal R, G, or B. According to an embodiment, a new digital color signal R, G, or B is determined when index IB corresponds to an image pixel having a dark tone and no new digital color signal R, G, or B is determined when index IB corresponds to an image pixel having a light tone. When no new digital color signal R, G, or B is determined, data signals Dataⱼ sent to pixel 12_{i,j} correspond then to the initial digital color signal R, G, or B. According to an embodiment, a new digital color signal R, G, or B is determined when index IB corresponds to an image pixel having a dark tone, based on the initial digital color signal R, G, or B. As an example, when index IB corresponds to an image pixel having a dark tone, new digital color signal R, G, or B are determined by circuit 26 so that the image pixel informational content is coded over all the NB bits of the digital color signal R, G, or B.

According to an embodiment, index IB is sent to display pixel 12_{i,j} using data signal Dataⱼ in addition to the bits of the initial or new digital color signal R, G, B. As an example, when digital color signal R, G, B is coded on NB bits and index IB is coded on one bit, data signal Dataⱼ is used to send NB+1 bits to display pixel 12_{i,j} for each digital color signal R, G, B. According to another embodiment, index IB is sent to display pixel 12_{i,j} using both data signal Dataⱼ and timing signal Comᵢ, for example by providing simultaneous specific patterns for data signal Dataⱼ and timing signal Comᵢ. According to another embodiment, index IB is sent to display pixel 12_{i,j} using data signal Dataⱼ by specific determination of one or more bits of the digital color signal R, G, B, according to a determined logic, for example one of the least significant bit bit₁, the second to the least significant bit bit₂, or the third to the least significant bit bit₃ of the digital color signal R, G, B. The display pixel 12_{i,j} is then adapted to extract index IB from the stored digital color signal R, G, B.

According to an embodiment, index IB is at logical state “1” for an image pixel having a light tone and index IB is at logical state “0” for an image pixel having a dark tone. More precisely, in a first operating mode, for displaying an image pixel having a light tone (index IB at logical state “1”), durations TA_{NB} to TA₁ are used to drive light emitting diode LED, the current source CS supplying light emitting diode LED being turned on or off during the successive durations TA_{NB} to TA₁ according to the logical value “0” or “1” of each bit b_{NB} to b₁ of digital color signal R, G, or B starting from the most significant bit b_{NB} of digital color signal R, G, or B and, in a second operating mode, for displaying an image pixel having a dark tone (index IB at logical state “0”), durations TB_{NB} to TB₁ are used to drive light emitting diode LED, the current source CS supplying light emitting diode LED being turned on or off during the successive durations TB_{NB} to TB₁ according to the logical value “0” or “1” of each bit b_{NB} to b₁ of digital color signal R, G, or B starting from the most significant bit b_{NB} of digital color signal R, and being turned off between two successive durations TB_{NB} to TB₁. As an example, in FIG. 6, signal I_red_W is obtained by using durations TA_{NB} to TA₁ and signal I_red_B is obtained by using durations TB_{NB} to TB₁.

As a variation, when current source CS corresponds to a MOS transistor, this transistor can be turned on or off, during the durations TAᵢ or TBⱼ, according to the logical value “0” or “1” of each bit of color signal R, G, or B from the least significant bit to the most significant bit of color signal R G, or B. In that case, the duration TAᵢ, i being in the range from NB to 1, between two successive first pulses PA of modulation timing signal PWM in a display cycle is multiplied each time by two, and the duration TBⱼ, j being in the range from NB to 1, between a first pulse PA and the successive second pulse PB of modulation timing signal PWM is multiplied by two with respect to the duration between the preceding successive first pulse PA and second pulse PB.

The display method according to the present embodiment with the modulation timing signal PWM comprising first and second pulses PA and PB and a digital color signal comprising NB bits is equivalent to a display method in which the modulation timing signal PWM comprises only first pulses and a digital color signal comprising NT bits bⱼ′, j being in the range from 1 to NT. Therefore, a color depth of NT bits is advantageously obtained with a color digital image coded on NB bits. In FIG. 6, the correspondence between the bit bᵢ, i being in the range from 1 to 5, and the bit bⱼ′, j being in the range from 1 to 8, is indicated.

FIG. 7 shows a block diagram of an embodiment of a part of circuit 40 of FIG. 4.

Circuit 40 comprises:
a circuit 60 configured to receive modulation timing signal PWM and to provide signal PWM2;
storage circuit 48 comprising a shift register clocked by signal PWM2, in which is stored digital color signal R, G or B and providing a binary signal/bⱼ at its output QB;
a circuit 62 configured to provide binary index IB; and
a logic circuit 64 configured to receive signals/bᵢ, IB, and PWM2 and to provide control binary signal I_red, I_green or I_blue.

Binary signal/bᵢ is the logical complement of binary bit bᵢ of digital color signal R, G, or B. When clocked by signal PWM2, shift register 48 successively provides at its output QB bit/bᵢ, that is the logical complement of bit bᵢ, i being in the range NB to 1, starting from the complement of the most significant bit b_{NB}. Circuit 60 is to provide signal PWM2 comprising a rising edge at each first pulse PA and a falling edge at each second pulse PB.

According to an embodiment, circuit 62 comprises a memory in which index IB is stored when received by display pixel 12_{i,j}. According to an embodiment, index IB is stored in shift register 48 and is used for the driving of the light-emitting diode LED by pulse-width modulation with the shortest of the duration TA₁ or TB₁ so that it substantially does not have an impact on the total lightning duration of the light-emitting diode LED. As an example, when index IB is equal to logical state “1” for the light tones and is stored in the shift register 48, the driving of the light-emitting diode LED by pulse-width modulation with the shortest duration TA₁ associated with the index IB equal to “1” would substantially not impact the total duration during which the light-emitting diode LED is on. The shortest duration TA₁ is advantageously set as low as possible.

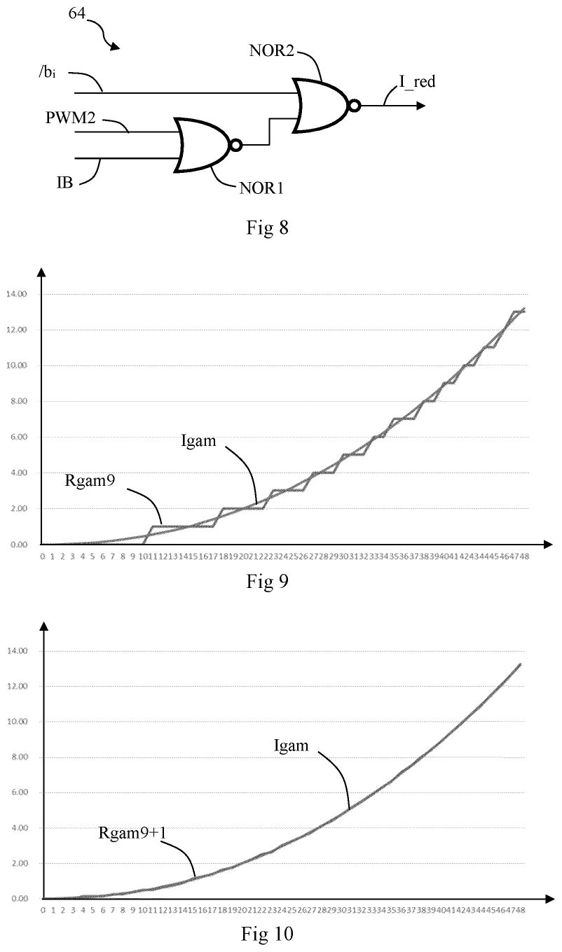

FIG. 8 shows a block diagram of an embodiment of logic circuit 64 of FIG. 7. Logic circuit 64 comprises:
a first logic gate NOR1 of NOR type having a first input receiving binary signal PWM2 and having a second input receiving binary index IB; and
a second logic gate NOR2 of NOR type having a first input receiving binary signal /bᵢ and having a second input receiving the binary signal provided at the output of first logic gate NOR1 and providing control binary signal I_red (or I_green or I_blue).

In the present embodiment, in the first operating mode, for light tones, binary index IB is set at logical value “1”. Therefore, the output of first logic gate NOR1 remains at logical value “0” during the whole display cycle and the output I_red (or I_green or I_blue) of second logic gate NOR2 is equal to binary logical complement of binary signal/bᵢ, that is to say equal to the bit bᵢ.

Since shift registry 48 is clocked by signal PWM2, logic circuit 64 provides successively the NB bits of digital color signal R clocked by signal PWM2, preferably at each rising edge of signal PWM2. The rising edges of signal PWM2 are simultaneous to the rising edges of the first pulses PA of modulation timing signal PWM. Then a pulse-width modulation is obtained in the first operation mode with durations TA_{NB} to TA₁.

In the present embodiment, in the second operating mode, for dark tones, binary index IB is set at logical value “0”. Therefore, the output of first logic gate NOR1 is equal to the logical complement of binary signal PWM2. When signal PWM2 is at logical state “0”, the output of first logic gate NOR1 is equal to logical state “1” and the output I_red of second logic gate NOR2 is equal to logic state “0”. The light emitting diode LED is then switched off. When signal PWM2 is at logical state “1”, that is between each first pulse PA and the successive second pulse PB, the output of first logic gate NOR1 is set at logical value “0” and the output I_red of second logic gate NOR2 is equal to the logical complement of binary signal/bᵢ, that is to say equal to bit bᵢ of digital color signal R stored in shift registry 48. Then a pulse-width modulation is obtained with the second operation mode with durations TB_{NB} to TB₁.

As an example, Table 1 below comprises:
in the first column entitled “Gray Scale (8-bit)”, the 256 gray scale values in decimal notation that can be coded with 8 bits;
in the second column entitled “Ideal Linear (9-bit)”, the corresponding ideal obtained values in decimal notation after a linear conversion;
in the third column entitled “Ideal 2.2 (9-bit)”, the corresponding ideal obtained values in decimal notation after a gamma conversion with γ equal to 2.2;
in the fourth column entitled “Real (9-bit)”, the corresponding real values in decimal notation after a gamma conversion with y equal to 2.2 that can be coded with 9 bits;
in the fifth column entitled “Real (9-bit) Binary without modification”, the same values as in the fourth column in a binary notation;
in the sixth column entitled “Index IB”, the index value IB associated corresponding to the value of the fifth column;
in the seventh column entitled “Real (9-bit) Binary with modification”, the 9-bit digital color signal sent to the display pixel 12_{i,j}; and
in the eight column entitled “Real (9+1-bit)”, the real obtained values in decimal notation corresponding to the 9-bit digital color signal of the seventh column.

For Table 1, index IB is set to the logical state “0” if all of bits b_{NB} to b_{NB-2} of digital color signal R, G, or B, are at the logical state “0” and index IB is set to the logical state “1” if at least one of bits b_{NB} to b_{NB-2} of digital color signal R, G, or B, is at logical state “1”. New digital color signal R, G, or B are determined when index IB is set to the logical state “0” and digital color signal R, G, or B are unchanged when index IB is set to the logical state “0”. New digital color signal R, G, or B are determined when index IB is set to the logical state “0” by coding the image pixel informational content over all the 9 bits of the digital color signal R, G, or B, that is to say by also using bits b_{NB} to b_{NB-2} of digital color signal R, G, or B, which originally should be equal to logic state “0”, to generate more value on the dark tones. As an example, when the second durations TBᵢ correspond to the first durations TAᵢ divided by 8, new digital color signal R, G, or B are determined by increasing 8 times the original image pixel value.

TABLE 1

| Gray | Ideal | Ideal | | Real (9-bit) | | Real (9-bit) | Real |
|---|---|---|---|---|---|---|---|
| Scale | Linear | 2.2 | Real | Binary without | Index | Binary with | (9 + |
| (8-bit) | (9-bit) | (9-bit) | (9-bit) | modification | IB | modification | 1-bit) |
| 0 | 0 | 0.00 | 0 | 000000000 | 0 | 000000000 | 0 |
| 1 | 3 | 0.01 | 0 | 000000000 | 0 | 000000000 | 0 |
| 2 | 5 | 0.02 | 0 | 000000000 | 0 | 000000000 | 0 |
| 3 | 7 | 0.04 | 0 | 000000000 | 0 | 000000000 | 0 |
| 4 | 9 | 0.07 | 0 | 000000000 | 0 | 000000001 | 0.125 |
| 5 | 11 | 0.11 | 0 | 000000000 | 0 | 000000001 | 0.125 |
| 6 | 13 | 0.16 | 0 | 000000000 | 0 | 000000001 | 0.125 |
| 7 | 15 | 0.22 | 0 | 000000000 | 0 | 000000010 | 0.25 |
| 8 | 17 | 0.29 | 0 | 000000000 | 0 | 000000010 | 0.25 |
| 9 | 19 | 0.37 | 0 | 000000000 | 0 | 000000011 | 0.375 |
| 10 | 21 | 0.46 | 0 | 000000000 | 0 | 000000100 | 0.5 |
| 11 | 23 | 0.56 | 1 | 000000001 | 0 | 000000100 | 0.5 |
| 12 | 25 | 0.67 | 1 | 000000001 | 0 | 000000101 | 0.625 |
| 13 | 27 | 0.79 | 1 | 000000001 | 0 | 000000110 | 0.75 |
| 14 | 29 | 0.93 | 1 | 000000001 | 0 | 000000111 | 0.875 |
| 15 | 31 | 1.07 | 1 | 000000001 | 0 | 000001001 | 1.125 |
| 16 | 33 | 1.23 | 1 | 000000001 | 0 | 000001010 | 1.25 |
| 17 | 35 | 1.40 | 1 | 000000001 | 0 | 000001011 | 1.375 |
| 18 | 37 | 1.58 | 2 | 000000010 | 0 | 000001101 | 1.625 |
| 19 | 39 | 1.78 | 2 | 000000010 | 0 | 000001110 | 1.75 |
| 20 | 41 | 1.99 | 2 | 000000010 | 0 | 000010000 | 2 |
| 21 | 43 | 2.21 | 2 | 000000010 | 0 | 000010010 | 2.25 |
| 22 | 45 | 2.44 | 2 | 000000010 | 0 | 000010100 | 2.5 |
| 23 | 47 | 2.68 | 3 | 000000011 | 0 | 000010101 | 2.625 |
| 24 | 49 | 2.94 | 3 | 000000011 | 0 | 000011000 | 3 |
| 25 | 51 | 3.21 | 3 | 000000011 | 0 | 000011010 | 3.25 |
| 26 | 53 | 3.49 | 3 | 000000011 | 0 | 000011100 | 3.5 |
| 27 | 55 | 3.79 | 4 | 000000100 | 0 | 000011110 | 3.75 |
| 28 | 57 | 4.10 | 4 | 000000100 | 0 | 000100001 | 4.125 |
| 29 | 59 | 4.42 | 4 | 000000100 | 0 | 000100011 | 4.375 |
| 30 | 61 | 4.76 | 5 | 000000101 | 0 | 000100110 | 4.75 |
| 31 | 63 | 5.11 | 5 | 000000101 | 0 | 000101001 | 5.125 |
| 32 | 65 | 5.47 | 5 | 000000101 | 0 | 000101100 | 5.5 |
| 33 | 67 | 5.85 | 6 | 000000110 | 0 | 000101111 | 5.875 |
| 34 | 69 | 6.24 | 6 | 000000110 | 0 | 000110010 | 6.25 |
| 35 | 71 | 6.65 | 7 | 000000111 | 0 | 000110101 | 6.625 |
| 36 | 73 | 7.07 | 7 | 000000111 | 0 | 000111001 | 7.125 |
| 37 | 75 | 7.50 | 7 | 000000111 | 0 | 000111100 | 7.5 |
| 38 | 77 | 7.95 | 8 | 000001000 | 0 | 001000000 | 8 |
| 39 | 79 | 8.41 | 8 | 000001000 | 0 | 001000011 | 8.375 |
| 40 | 81 | 8.88 | 9 | 000001001 | 0 | 001000111 | 8.875 |
| 41 | 83 | 9.37 | 9 | 000001001 | 0 | 001001011 | 9.375 |
| 42 | 85 | 9.88 | 10 | 000001010 | 0 | 001001111 | 9.875 |
| 43 | 87 | 10.40 | 10 | 000001010 | 0 | 001010011 | 10.375 |
| 44 | 89 | 10.93 | 11 | 000001011 | 0 | 001010111 | 10.875 |
| 45 | 91 | 11.48 | 11 | 000001011 | 0 | 001011100 | 11.5 |
| 46 | 93 | 12.04 | 12 | 000001100 | 0 | 001100000 | 12 |
| 47 | 95 | 12.61 | 13 | 000001101 | 0 | 001100101 | 12.625 |
| 48 | 97 | 13.21 | 13 | 000001101 | 0 | 001101010 | 13.25 |
| 49 | 99 | 13.81 | 14 | 000001110 | 0 | 001101111 | 13.875 |
| 50 | 101 | 14.43 | 14 | 000001110 | 0 | 001110011 | 14.375 |
| 51 | 103 | 15.07 | 15 | 000001111 | 0 | 001111001 | 15.125 |
| 52 | 105 | 15.72 | 16 | 000010000 | 0 | 001111110 | 15.75 |
| 53 | 107 | 16.39 | 16 | 000010000 | 0 | 010000011 | 16.375 |
| 54 | 109 | 17.07 | 17 | 000010001 | 0 | 010001001 | 17.125 |
| 55 | 111 | 17.77 | 18 | 000010010 | 0 | 010001110 | 17.75 |
| 56 | 113 | 18.48 | 18 | 000010010 | 0 | 010010100 | 18.5 |
| 57 | 115 | 19.21 | 19 | 000010011 | 0 | 010011010 | 19.25 |
| 58 | 117 | 19.95 | 20 | 000010100 | 0 | 010100000 | 20 |
| 59 | 119 | 20.71 | 21 | 000010101 | 0 | 010100110 | 20.75 |
| 60 | 121 | 21.48 | 21 | 000010101 | 0 | 010101100 | 21.5 |
| 61 | 123 | 22.27 | 22 | 000010110 | 0 | 010110010 | 22.25 |
| 62 | 125 | 23.07 | 23 | 000010111 | 0 | 010111001 | 23.125 |
| 63 | 127 | 23.89 | 24 | 000011000 | 0 | 010111111 | 23.875 |
| 64 | 129 | 24.73 | 25 | 000011001 | 0 | 011000110 | 24.75 |
| 65 | 131 | 25.58 | 26 | 000011010 | 0 | 011001101 | 25.625 |
| 66 | 133 | 26.45 | 26 | 000011010 | 0 | 011010100 | 26.5 |
| 67 | 135 | 27.33 | 27 | 000011011 | 0 | 011011011 | 27.375 |
| 68 | 137 | 28.23 | 28 | 000011100 | 0 | 011100010 | 28.25 |
| 69 | 139 | 29.14 | 29 | 000011101 | 0 | 011101001 | 29.125 |
| 70 | 141 | 30.07 | 30 | 000011110 | 0 | 011110001 | 30.125 |
| 71 | 143 | 31.02 | 31 | 000011111 | 0 | 011111000 | 31 |
| 72 | 145 | 31.98 | 32 | 000100000 | 0 | 100000000 | 32 |
| 73 | 147 | 32.96 | 33 | 000100001 | 0 | 100001000 | 33 |
| 74 | 149 | 33.96 | 34 | 000100010 | 0 | 100010000 | 34 |
| 75 | 151 | 34.97 | 35 | 000100011 | 0 | 100011000 | 35 |
| 76 | 153 | 35.99 | 36 | 000100100 | 0 | 100100000 | 36 |
| 77 | 155 | 37.04 | 37 | 000100101 | 0 | 100101000 | 37 |
| 78 | 157 | 38.10 | 38 | 000100110 | 0 | 100110001 | 38.125 |
| 79 | 159 | 39.17 | 39 | 000100111 | 0 | 100111001 | 39.125 |
| 80 | 161 | 40.26 | 40 | 000101000 | 0 | 101000010 | 40.25 |
| 81 | 163 | 41.37 | 41 | 000101001 | 0 | 101001011 | 41.375 |
| 82 | 165 | 42.50 | 42 | 000101010 | 0 | 101010100 | 42.5 |
| 83 | 167 | 43.64 | 44 | 000101100 | 0 | 101011101 | 43.625 |
| 84 | 169 | 44.80 | 45 | 000101101 | 0 | 101100110 | 44.75 |
| 85 | 171 | 45.97 | 46 | 000101110 | 0 | 101110000 | 46 |
| 86 | 173 | 47.16 | 47 | 000101111 | 0 | 101111001 | 47.125 |
| 87 | 175 | 48.37 | 48 | 000110000 | 0 | 110000011 | 48.375 |
| 88 | 177 | 49.59 | 50 | 000110010 | 0 | 110001101 | 49.625 |
| 89 | 179 | 50.84 | 51 | 000110011 | 0 | 110010111 | 50.875 |
| 90 | 181 | 52.09 | 52 | 000110100 | 0 | 110100001 | 52.125 |
| 91 | 183 | 53.37 | 53 | 000110101 | 0 | 110101011 | 53.375 |
| 92 | 185 | 54.66 | 55 | 000110111 | 0 | 110110101 | 54.625 |
| 93 | 187 | 55.97 | 56 | 000111000 | 0 | 111000000 | 56 |
| 94 | 189 | 57.29 | 57 | 000111001 | 0 | 111001010 | 57.25 |
| 95 | 191 | 58.64 | 59 | 000111011 | 0 | 111010101 | 58.625 |
| 96 | 193 | 60.00 | 60 | 000111100 | 0 | 111100000 | 60 |
| 97 | 195 | 61.37 | 61 | 000111101 | 0 | 111101011 | 61.375 |
| 98 | 197 | 62.77 | 63 | 000111111 | 0 | 111110110 | 62.75 |
| 99 | 199 | 64.18 | 64 | 001000000 | 1 | 001000000 | 64 |
| 100 | 201 | 65.60 | 66 | 001000010 | 1 | 001000010 | 66 |
| 101 | 203 | 67.05 | 67 | 001000011 | 1 | 001000011 | 67 |
| 102 | 205 | 68.51 | 69 | 001000101 | 1 | 001000101 | 69 |
| 103 | 207 | 69.99 | 70 | 001000110 | 1 | 001000110 | 70 |
| 104 | 209 | 71.49 | 71 | 001000111 | 1 | 001000111 | 71 |
| 105 | 211 | 73.00 | 73 | 001001001 | 1 | 001001001 | 73 |
| 106 | 213 | 74.53 | 75 | 001001011 | 1 | 001001011 | 75 |
| 107 | 215 | 76.08 | 76 | 001001100 | 1 | 001001100 | 76 |
| 108 | 217 | 77.64 | 78 | 001001110 | 1 | 001001110 | 78 |
| 109 | 219 | 79.23 | 79 | 001001111 | 1 | 001001111 | 79 |
| 110 | 221 | 80.83 | 81 | 001010001 | 1 | 001010001 | 81 |
| 111 | 223 | 82.45 | 82 | 001010010 | 1 | 001010010 | 82 |
| 112 | 225 | 84.08 | 84 | 001010100 | 1 | 001010100 | 84 |
| 113 | 227 | 85.73 | 86 | 001010110 | 1 | 001010110 | 86 |
| 114 | 229 | 87.40 | 87 | 001010111 | 1 | 001010111 | 87 |
| 115 | 231 | 89.09 | 89 | 001011001 | 1 | 001011001 | 89 |
| 116 | 233 | 90.80 | 91 | 001011011 | 1 | 001011011 | 91 |
| 117 | 235 | 92.52 | 93 | 001011101 | 1 | 001011101 | 93 |
| 118 | 237 | 94.26 | 94 | 001011110 | 1 | 001011110 | 94 |
| 119 | 239 | 96.02 | 96 | 001100000 | 1 | 001100000 | 96 |
| 120 | 241 | 97.80 | 98 | 001100010 | 1 | 001100010 | 98 |
| 121 | 243 | 99.59 | 100 | 001100100 | 1 | 001100100 | 100 |
| 122 | 245 | 101.41 | 101 | 001100101 | 1 | 001100101 | 101 |
| 123 | 247 | 103.24 | 103 | 001100111 | 1 | 001100111 | 103 |
| 124 | 249 | 105.08 | 105 | 001101001 | 1 | 001101001 | 105 |
| 125 | 251 | 106.95 | 107 | 001101011 | 1 | 001101011 | 107 |
| 126 | 253 | 108.83 | 109 | 001101101 | 1 | 001101101 | 109 |
| 127 | 255 | 110.73 | 111 | 001101111 | 1 | 001101111 | 111 |
| 128 | 257 | 112.65 | 113 | 001110001 | 1 | 001110001 | 113 |
| 129 | 259 | 114.59 | 115 | 001110011 | 1 | 001110011 | 115 |
| 130 | 261 | 116.55 | 117 | 001110101 | 1 | 001110101 | 117 |
| 131 | 263 | 118.52 | 119 | 001110111 | 1 | 001110111 | 119 |
| 132 | 265 | 120.51 | 121 | 001111001 | 1 | 001111001 | 121 |
| 133 | 267 | 122.52 | 123 | 001111011 | 1 | 001111011 | 123 |
| 134 | 269 | 124.55 | 125 | 001111101 | 1 | 001111101 | 125 |
| 135 | 271 | 126.60 | 127 | 001111111 | 1 | 001111111 | 127 |
| 136 | 273 | 128.66 | 129 | 010000001 | 1 | 010000001 | 129 |
| 137 | 275 | 130.75 | 131 | 010000011 | 1 | 010000011 | 131 |
| 138 | 277 | 132.85 | 133 | 010000101 | 1 | 010000101 | 133 |
| 139 | 279 | 134.97 | 135 | 010000111 | 1 | 010000111 | 135 |
| 140 | 281 | 137.10 | 137 | 010001001 | 1 | 010001001 | 137 |
| 141 | 283 | 139.26 | 139 | 010001011 | 1 | 010001011 | 139 |
| 142 | 285 | 141.43 | 141 | 010001101 | 1 | 010001101 | 141 |
| 143 | 287 | 143.63 | 144 | 010010000 | 1 | 010010000 | 144 |
| 144 | 289 | 145.84 | 146 | 010010010 | 1 | 010010010 | 146 |
| 145 | 291 | 148.07 | 148 | 010010100 | 1 | 010010100 | 148 |
| 146 | 293 | 150.32 | 150 | 010010110 | 1 | 010010110 | 150 |
| 147 | 295 | 152.58 | 153 | 010011001 | 1 | 010011001 | 153 |
| 148 | 297 | 154.87 | 155 | 010011011 | 1 | 010011011 | 155 |
| 149 | 299 | 157.17 | 157 | 010011101 | 1 | 010011101 | 157 |
| 150 | 301 | 159.49 | 159 | 010011111 | 1 | 010011111 | 159 |
| 151 | 303 | 161.83 | 162 | 010100010 | 1 | 010100010 | 162 |
| 152 | 305 | 164.19 | 164 | 010100100 | 1 | 010100100 | 164 |
| 153 | 307 | 166.57 | 167 | 010100111 | 1 | 010100111 | 167 |
| 154 | 309 | 168.97 | 169 | 010101001 | 1 | 010101001 | 169 |
| 155 | 311 | 171.38 | 171 | 010101011 | 1 | 010101011 | 171 |
| 156 | 313 | 173.82 | 174 | 010101110 | 1 | 010101110 | 174 |
| 157 | 315 | 176.27 | 176 | 010110000 | 1 | 010110000 | 176 |
| 158 | 317 | 178.74 | 179 | 010110011 | 1 | 010110011 | 179 |
| 159 | 319 | 181.23 | 181 | 010110101 | 1 | 010110101 | 181 |
| 160 | 321 | 183.74 | 184 | 010111000 | 1 | 010111000 | 184 |
| 161 | 323 | 186.27 | 186 | 010111010 | 1 | 010111010 | 186 |
| 162 | 325 | 188.82 | 189 | 010111101 | 1 | 010111101 | 189 |
| 163 | 327 | 191.38 | 191 | 010111111 | 1 | 010111111 | 191 |
| 164 | 329 | 193.97 | 194 | 011000010 | 1 | 011000010 | 194 |
| 165 | 331 | 196.57 | 197 | 011000101 | 1 | 011000101 | 197 |
| 166 | 333 | 199.19 | 199 | 011000111 | 1 | 011000111 | 199 |
| 167 | 335 | 201.83 | 202 | 011001010 | 1 | 011001010 | 202 |
| 168 | 337 | 204.49 | 204 | 011001100 | 1 | 011001100 | 204 |
| 169 | 339 | 207.17 | 207 | 011001111 | 1 | 011001111 | 207 |
| 170 | 341 | 209.87 | 210 | 011010010 | 1 | 011010010 | 210 |
| 171 | 343 | 212.59 | 213 | 011010101 | 1 | 011010101 | 213 |
| 172 | 345 | 215.33 | 215 | 011010111 | 1 | 011010111 | 215 |
| 173 | 347 | 218.08 | 218 | 011011010 | 1 | 011011010 | 218 |
| 174 | 349 | 220.86 | 221 | 011011101 | 1 | 011011101 | 221 |
| 175 | 351 | 223.65 | 224 | 011100000 | 1 | 011100000 | 224 |
| 176 | 353 | 226.46 | 226 | 011100010 | 1 | 011100010 | 226 |
| 177 | 355 | 229.30 | 229 | 011100101 | 1 | 011100101 | 229 |
| 178 | 357 | 232.15 | 232 | 011101000 | 1 | 011101000 | 232 |
| 179 | 359 | 235.02 | 235 | 011101011 | 1 | 011101011 | 235 |
| 180 | 361 | 237.91 | 238 | 011101110 | 1 | 011101110 | 238 |
| 181 | 363 | 240.82 | 241 | 011110001 | 1 | 011110001 | 241 |
| 182 | 365 | 243.75 | 244 | 011110100 | 1 | 011110100 | 244 |
| 183 | 367 | 246.69 | 247 | 011110111 | 1 | 011110111 | 247 |
| 184 | 369 | 249.66 | 250 | 011111010 | 1 | 011111010 | 250 |
| 185 | 371 | 252.65 | 253 | 011111101 | 1 | 011111101 | 253 |
| 186 | 373 | 255.66 | 256 | 100000000 | 1 | 100000000 | 256 |
| 187 | 375 | 258.68 | 259 | 100000011 | 1 | 100000011 | 259 |
| 188 | 377 | 261.73 | 262 | 100000110 | 1 | 100000110 | 262 |
| 189 | 379 | 264.79 | 265 | 100001001 | 1 | 100001001 | 265 |
| 190 | 381 | 267.87 | 268 | 100001100 | 1 | 100001100 | 268 |
| 191 | 383 | 270.98 | 271 | 100001111 | 1 | 100001111 | 271 |
| 192 | 385 | 274.10 | 274 | 100010010 | 1 | 100010010 | 274 |
| 193 | 387 | 277.24 | 277 | 100010101 | 1 | 100010101 | 277 |
| 194 | 389 | 280.40 | 280 | 100011000 | 1 | 100011000 | 280 |
| 195 | 391 | 283.59 | 284 | 100011100 | 1 | 100011100 | 284 |
| 196 | 393 | 286.79 | 287 | 100011111 | 1 | 100011111 | 287 |
| 197 | 395 | 290.01 | 290 | 100100010 | 1 | 100100010 | 290 |
| 198 | 397 | 293.25 | 293 | 100100101 | 1 | 100100101 | 293 |
| 199 | 399 | 296.51 | 297 | 100101001 | 1 | 100101001 | 297 |
| 200 | 401 | 299.79 | 300 | 100101100 | 1 | 100101100 | 300 |
| 201 | 403 | 303.09 | 303 | 100101111 | 1 | 100101111 | 303 |
| 202 | 405 | 306.41 | 306 | 100110010 | 1 | 100110010 | 306 |
| 203 | 407 | 309.74 | 310 | 100110110 | 1 | 100110110 | 310 |
| 204 | 409 | 313.10 | 313 | 100111001 | 1 | 100111001 | 313 |
| 205 | 411 | 316.48 | 316 | 100111100 | 1 | 100111100 | 316 |
| 206 | 413 | 319.88 | 320 | 101000000 | 1 | 101000000 | 320 |
| 207 | 415 | 323.30 | 323 | 101000011 | 1 | 101000011 | 323 |
| 208 | 417 | 326.73 | 327 | 101000111 | 1 | 101000111 | 327 |
| 209 | 419 | 330.19 | 330 | 101001010 | 1 | 101001010 | 330 |
| 210 | 421 | 333.67 | 334 | 101001110 | 1 | 101001110 | 334 |
| 211 | 423 | 337.17 | 337 | 101010001 | 1 | 101010001 | 337 |
| 212 | 425 | 340.68 | 341 | 101010101 | 1 | 101010101 | 341 |
| 213 | 427 | 344.22 | 344 | 101011000 | 1 | 101011000 | 344 |
| 214 | 429 | 347.78 | 348 | 101011100 | 1 | 101011100 | 348 |
| 215 | 431 | 351.35 | 351 | 101011111 | 1 | 101011111 | 351 |
| 216 | 433 | 354.95 | 355 | 101100011 | 1 | 101100011 | 355 |
| 217 | 435 | 358.57 | 359 | 101100111 | 1 | 101100111 | 359 |
| 218 | 437 | 362.20 | 362 | 101101010 | 1 | 101101010 | 362 |
| 219 | 439 | 365.86 | 366 | 101101110 | 1 | 101101110 | 366 |
| 220 | 441 | 369.54 | 370 | 101110010 | 1 | 101110010 | 370 |
| 221 | 443 | 373.24 | 373 | 101110101 | 1 | 101110101 | 373 |
| 222 | 445 | 376.95 | 377 | 101111001 | 1 | 101111001 | 377 |
| 223 | 447 | 380.69 | 381 | 101111101 | 1 | 101111101 | 381 |
| 224 | 449 | 384.45 | 384 | 110000000 | 1 | 110000000 | 384 |
| 225 | 451 | 388.22 | 388 | 110000100 | 1 | 110000100 | 388 |
| 226 | 453 | 392.02 | 392 | 110001000 | 1 | 110001000 | 392 |
| 227 | 455 | 395.84 | 396 | 110001100 | 1 | 110001100 | 396 |
| 228 | 457 | 399.68 | 400 | 110010000 | 1 | 110010000 | 400 |
| 229 | 459 | 403.54 | 404 | 110010100 | 1 | 110010100 | 404 |
| 230 | 461 | 407.41 | 407 | 110010111 | 1 | 110010111 | 407 |
| 231 | 463 | 411.31 | 411 | 110011011 | 1 | 110011011 | 411 |
| 232 | 465 | 415.23 | 415 | 110011111 | 1 | 110011111 | 415 |
| 233 | 467 | 419.17 | 419 | 110100011 | 1 | 110100011 | 419 |
| 234 | 469 | 423.13 | 423 | 110100111 | 1 | 110100111 | 423 |
| 235 | 471 | 427.11 | 427 | 110101011 | 1 | 110101011 | 427 |
| 236 | 473 | 431.11 | 431 | 110101111 | 1 | 110101111 | 431 |
| 237 | 475 | 435.13 | 435 | 110110011 | 1 | 110110011 | 435 |
| 238 | 477 | 439.17 | 439 | 110110111 | 1 | 110110111 | 439 |
| 239 | 479 | 443.23 | 443 | 110111011 | 1 | 110111011 | 443 |
| 240 | 481 | 447.32 | 447 | 110111111 | 1 | 110111111 | 447 |
| 241 | 483 | 451.42 | 451 | 111000011 | 1 | 111000011 | 451 |
| 242 | 485 | 455.54 | 456 | 111001000 | 1 | 111001000 | 456 |
| 243 | 487 | 459.68 | 460 | 111001100 | 1 | 111001100 | 460 |
| 244 | 489 | 463.85 | 464 | 111010000 | 1 | 111010000 | 464 |
| 245 | 491 | 468.03 | 468 | 111010100 | 1 | 111010100 | 468 |
| 246 | 493 | 472.23 | 472 | 111011000 | 1 | 111011000 | 472 |
| 247 | 495 | 476.46 | 476 | 111011100 | 1 | 111011100 | 476 |
| 248 | 497 | 480.71 | 481 | 111100001 | 1 | 111100001 | 481 |
| 249 | 499 | 484.97 | 485 | 111100101 | 1 | 111100101 | 485 |
| 250 | 501 | 489.26 | 489 | 111101001 | 1 | 111101001 | 489 |
| 251 | 503 | 493.57 | 494 | 111101110 | 1 | 111101110 | 494 |
| 252 | 505 | 497.89 | 498 | 111110010 | 1 | 111110010 | 498 |
| 253 | 507 | 502.24 | 502 | 111110110 | 1 | 111110110 | 502 |
| 254 | 509 | 506.61 | 507 | 111111011 | 1 | 111111011 | 507 |
| 255 | 511 | 511.00 | 511 | 111111111 | 1 | 111111111 | 511 |

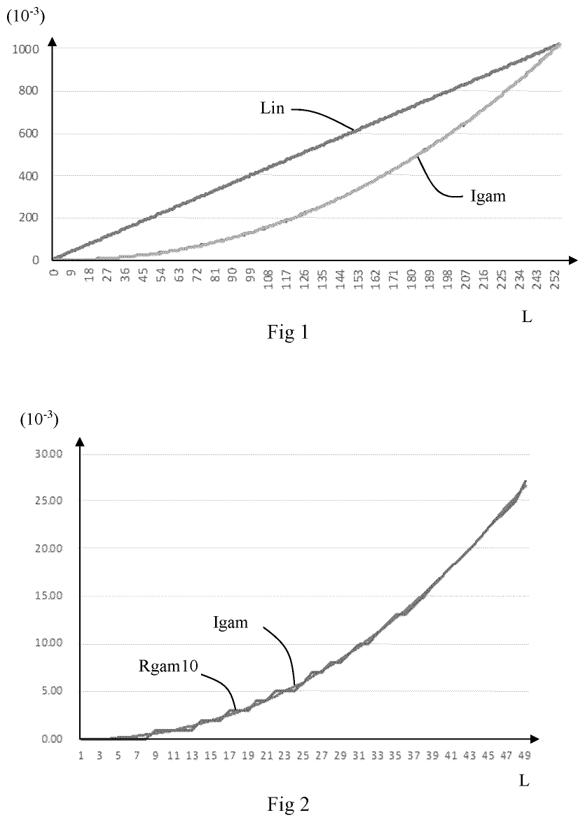

FIG. 9 is a Figure similar to FIG. 2 and shows an enlarged view of the ideal gamma decoding function Igam of FIG. 2 and the gamma decoding function Rgam9 really obtained with a coding on 9 bits.

FIG. 10 shows an enlarged view of the ideal gamma decoding function Igam of FIG. 1 and a gamma decoding function Rgam9+1 really obtained with the embodiment of the method for displaying the image pixel disclosed previously in relation to FIG. 6 and corresponding to Table 1. Curve Rgam9+1 follows more closely curve Igam than does curve Rgam9 and also than does curve Rgam10 shown in FIG. 2.

According to an embodiment of the display screen 10 shown in FIG. 3, for each row, the display pixels 12_{i,j} in the row are coupled to a single row electrode 18ᵢ. For each column, the display pixels 12_{i,j} in the column are coupled to a single column electrode 20ⱼ.

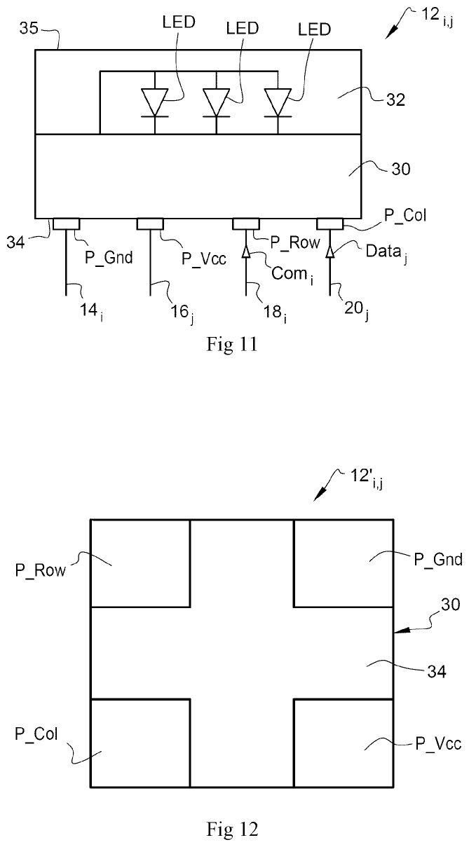

FIG. 11 is a very simplified cross-section view of a known example of display pixel 12_{i,j} and FIG. 12 is a bottom view of display pixel 12_{i,j}. Each display pixel 12_{i,j} comprises a control circuit 30 covered with a display circuit 32. Display circuit 32 comprises at least one light-emitting diode LED, preferably at least three light-emitting diodes LED. The display pixel comprises a lower surface 34 and an upper surface 35 opposite to lower surface 34, surfaces 34 and 35 being preferably planar and parallel. Control circuit 30 further comprises conductive pads P_Gnd, P_Vcc, P_Col, P_Row on lower surface 34. Control circuit 30 may correspond to an integrated circuit comprising electronic components, particularly insulated gate field effect transistors, also called MOS transistors, or thin film transistors, also called TFTs. Preferably, display circuit 32 only comprises light-emitting diodes LED and the conductive elements of these light-emitting diodes LED, and control circuit 30 comprises all the electronic components necessary to the control of the light-emitting diodes LED of display circuit 32. As a variant, display circuit 32 may also comprise other electronic components in addition to light-emitting diodes LED. Light-emitting diodes LED may be 2D light-emitting diodes, also called planar light-emitting diodes, comprising a stack of planar layers, or 3D light-emitting diodes, each comprising a three-dimensional semiconductor element covered with an active area. In FIG. 11, the light-emitting diodes are shown as being connected with a common anode. It may however be desirable to arrange light-emitting diodes LED according to another configuration. As an example, the light-emitting diodes may be connected with a common cathode, or be connected independently from one another.

According to an embodiment, display pixel 12_{i,j} comprises three display sub-pixels emitting light at first, second, and third wavelengths. According to an embodiment, the first wavelength corresponds to blue light and is within the range from 430 nm to 490 nm. According to an embodiment, the second wavelength corresponds to green light and is within the range from 510 nm to 570 nm. According to an embodiment, the third wavelength corresponds to red light and is within the range from 600 nm to 720 nm. As a variation, the display pixel 12_{i,j} can comprise only one light source emitting light at the first, second, or third wavelength, or only two light sources emitting light at two wavelengths among the first, second, and third wavelengths.

Each conductive pad P_Gnd, P_Vcc, P_Col, P_Row is intended to be connected to one of electrodes 14ᵢ, 16ⱼ, 18ᵢ, 20ⱼ schematically shown in FIG. 11. The first conductive pad P_Gnd is coupled to the source of low reference potential Gnd. The second conductive pad P_Vcc is coupled to the source of high reference potential Vcc. The third conductive pad P_Row is coupled to row electrode 18ᵢ and receives timing signal Comᵢ. The fourth conductive pad P_Col is coupled to column electrode 20ⱼ and receives data signal Dataⱼ. The dimensions of conductive pads P_Gnd, P_Vcc, P_Col, P_Row and the layout of conductive pads P_Gnd, P_Vcc, P_Col, P_Row on surface 34 are particularly imposed by the rules of design of display pixel 12_{i,j} and by the method of assembly of display pixels 12_{i,j} in display screen 10.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A display pixel comprising at least one light-emitting diode, and an electronic circuit comprising a storage circuit for storing at least one digital signal and a driver circuit configured to drive said light-emitting diode by pulse-width modulation, in a first operating mode, by switching on or off said light-emitting diode during first different durations according to the logical states of the bits of the digital signal or, in a second operating mode, by switching on or off said light-emitting diode during second different durations, at least partly different from the first durations, according to the logical states of the bits of the digital signal.

2. The display pixel of claim 1, wherein the electronic circuit is configured to switch between the first and second operating modes according to the logical state of a first binary signal.

3. The display pixel of claim 2, wherein the electronic circuit is configured to receive the first binary signal from outside the display pixel.

4. The display pixel of claim 1, wherein the digital signal comprises NB bits bᵢ, i being in the range from 1 to NB, bit b_{NB} being the most significant bit and bit b₁ being the least significant bit, wherein the first durations comprise NB first durations TAᵢ of increasing values, wherein the second durations comprise NB second durations TBᵢ of increasing values, wherein the driver circuit is configured to drive said light-emitting diode by pulse-width modulation in the first operating mode by switching on or off said light-emitting diode during the NB first durations TAᵢ, said light-emitting diode being switched on during first duration TAᵢ when bit bᵢ is at a first logical state and being switched off during first duration TAᵢ when bit bᵢ is at a second logical state, different from the first logical state, and wherein the driver circuit is configured to drive said light-emitting diode by pulse-width modulation in the second operating mode by switching on or off said light-emitting diode during the NB second durations TBᵢ, said light-emitting diode being switched on during second duration TBᵢ when bit bᵢ is at the first logical state and being switched off during second duration TBᵢ when bit bᵢ is at the second logical state.

5. The display pixel of claim 1, wherein at least some of the second durations are inferior to the first durations.

6. The display pixel of claim 1, wherein at least one of the second durations lasts as long as one of the first durations.

7. The display pixel of claim 6, wherein at least the longest second duration lasts as long as one of the first durations.

8. The display pixel of claim 1, comprising at least a first conductive pad intended to receive a second binary signal comprising pulses, and connected to said electronic circuit, some of said pulses being distant from the first durations and some of said pulses being distant from the second durations, said electronic circuit being configured to switch on or off said light-emitting diode during the first durations or the second durations based on said pulses.

9. The display pixel of claim 8, wherein the pulses comprise first pulses, the first pulses being distant from the first durations, and further comprise second pulses, each first pulse being followed by a second pulse, the first pulses and the following second pulses being distant from the second durations.

10. The display pixel of claim 9, wherein the electronic circuit is configured to generate a third binary signal from the second binary signal with a logical state that is modified at each first pulse and at each second pulse.

11. The display pixel of claim 10, wherein the storage circuit comprises a shift register in which is stored the digital signal and configured to provide the successive bits of the stored digital signal clocked by the third binary signal.

12. The display pixel of claim 1, comprising a controllable current source (CS) supplying said light-emitting diode and controlled by a fourth binary signal.

13. The display pixel of claim 2, wherein the electronic circuit comprises a first logic gate of NOR type having a first input receiving the third binary signal and having a second input receiving the first binary signal and a second logic gate of NOR type having a first input receiving the logical complement of bit bᵢ and having a second input connected to the output of first logic gate and providing the fourth binary signal.

14. A display pixel of claim 1, comprising at least a second conductive pad intended to receive a fifth binary signal, and connected to said electronic circuit, said electronic circuit being configured to update said stored digital signal in the storage circuit from the second signal.

15. A display screen comprising:
display pixels according to claim 1 arranged in rows and in columns;
first electrically conductive tracks extending along the rows and connected to the electronic circuits of the display pixels;
second electrically conductive tracks extending along the columns and connected to the electronic circuits of the display pixels; and
a control circuit connected to the first electrically conductive tracks and the second electrically conductive tracks.

16. The display screen of claim 15, wherein the electronic circuit of each display pixel is configured to switch between the first and second operating modes according to the logical state of a first binary signal, and wherein the control circuit is configured to determine the first binary signal for each digital signal and provide the first binary signals to the display pixels.

17. The display screen of claim 15, wherein the control circuit is configured to supply a timing signal on each first electrically conductive track, and wherein the electronic circuit of each display pixel is configured to generate from said timing signal a drive signal to drive said light-emitting diode by pulse-width modulation, in a first operating mode, by switching on or off said light-emitting diode during the first different durations or, in a second operating mode, by switching on or off said light-emitting diode during the second different durations.

18. The display screen of claim 17, wherein the control circuit is configured to supply the timing signal on each first electrically conductive track equal to a second binary signal comprising at least first pulses, the first pulses being distant from the first durations and second pulses, each first pulse being followed by a second pulse, the first pulses and the following second pulses being distant from the second durations.
